(19) United States
(12) Patent Application Publication
(10) Pub. No.: US 2006/0067337 A1
(43) Pub. Date: Mar. 30, 2006

(54) Methods and devices for generating a hierarchical structure for the internet

(76) Inventors: Arun Narayan Netravali, Westfield, NJ (US); Krishan Kumar Sabnani, Westfield, NJ (US); Ramesh Viswanathan, Manalapan, NJ (US)

Correspondence Address: HARNESS, DICKEY & PIERCE, P.L.C., P.O. Box 8910, Reston, VA, 20195, US

(21) Appl. No.: 10/953,551

(22) Filed: Sep. 30, 2004

(51) Int. Cl. H04L 12/56

(52) U.S. Cl. 370/400

(57) ABSTRACT

A hierarchical structure for the Internet only requires designated nodal elements, each within its own associated cluster of nodal elements, to compute routing paths to other similarly designated nodal elements outside of its cluster. In this manner, the number of routing paths needed to be computed by a given element is greatly reduced.

### BACKGROUND OF THE INVENTION

The Internet which exists today can be viewed as a number of diverse networks, each of which is capable of communicating with every other network to transfer information, messages, etc. (collectively referred to as “information”). When information needs to be transferred between nodal elements in different networks within the Internet, a device known as a “router” must compute an appropriate routing path between the elements. In particular, certain routers, using a protocol known as “Border Gateway Protocol” (BGP), are assigned the task of computing these paths. These routers are referred to as BGP “speaker nodes”. BGP speaker nodes must compute routing paths to every nodal element within every network.

This means that each BGP speaker node must have the ability to compute a path to every nodal element throughout the Internet. It also means that, when a single change is made to a network (e.g., a nodal element is added or deleted), each BGP speaker node must re-compute routing paths to every nodal element within every network.

In addition, as the number of new networks containing thousands of new nodal elements are added to the Internet the number of nodal elements that a given BGP speaker node must be capable of computing (and re-computing) a path to, will increase.

It is desirable, therefore, to provide a new Internet structure that reduces the number of paths which must be computed by a given nodal element, such as a BGP speaker node.

### SUMMARY OF THE INVENTION

We have recognized that the number of paths that must be computed by a given nodal element can be significantly reduced by generating a new hierarchical structure for the Internet. In one example of the present invention, this structure can be constructed by organizing one or more nodal elements into at least one nodal cluster, and then designating one of the nodal elements as a supernode. For example, a group of BGP speaker nodes may be grouped into a cluster where one of the speaker nodes is designated as a supernode.

Once designated, a supernode is responsible for computing routing paths to one or more other supernodes outside the cluster. It is no longer necessary to compute routing paths to every nodal element; only paths to other supernodes outside a given cluster need be computed.

Similarly, so-designated supernodes may themselves be arranged in clusters and a lead supernode may be designated for each supernodal cluster. The lead supernodes carry out routing path computations to other lead supernodes outside their cluster.

This process can be repeated until a number of layers are created, where within each layer, it is only necessary for designated nodal elements to compute routing paths to other similarly designated nodal elements outside of a given cluster within the same layer.

### BRIEF DESCRIPTION OF THE DRAWINGS

FIG. 1 is a simplified diagram of a hierarchical structure for the Internet which includes nodal cluster layers according to one embodiment of the present invention.

### DETAILED DESCRIPTION OF THE INVENTION

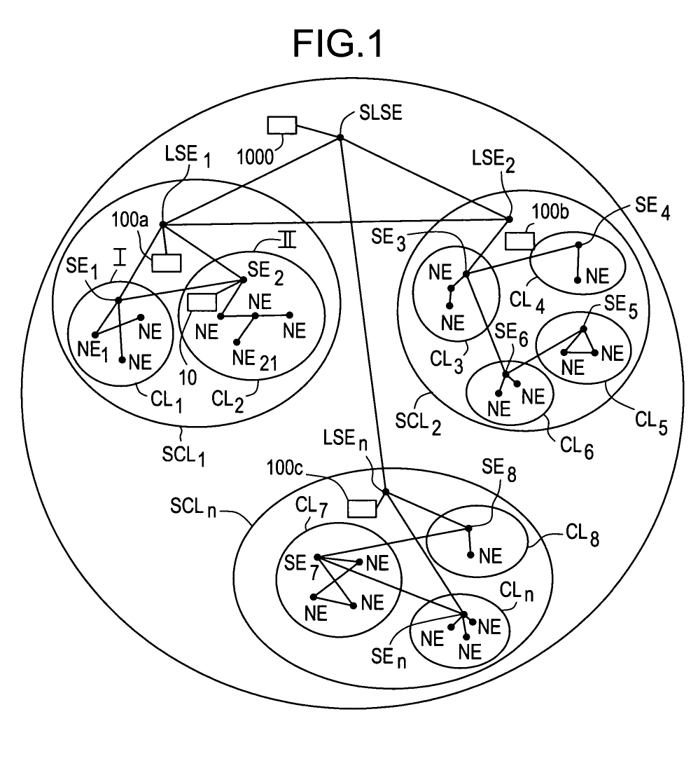

Referring to FIG. 1, there is shown a number of nodal elements, each designated as “NE”, “SE”, “LSE” or “SLSE”. The meaning of each type of nodal element will be explained below. For now, suffice it to say that each is originally configured as simply a nodal element (NE). Thereafter some NEs become SEs, LSEs or SLSEs as described further below.

In one embodiment of the present invention, each original NE may comprise a BGP speaker node. Instead of requiring a BGP speaker node to compute routing paths and forwarding tables to all NEs, the present invention generates a hierarchical structure which only requires a designated “supernode” to compute paths to other, similarly designated supernodes.

More particularly, in one embodiment of the present invention, one or more NEs are organized into an associated nodal cluster.

In FIG. 1, there is shown one or more clusters designated as CL_{1 . . . n} where each cluster comprises one or more NEs. In yet a further embodiment of the present invention, once the clusters have been formed, the present invention provides for designating at least one of the nodal elements within an associated cluster as a supernodal element (“SE”) also referred to as a supernode, for short.

Instead of requiring an SE to compute paths to every NE, the present invention only requires an SE to compute paths to other SEs outside a given cluster. It is believed by the present inventors that this greatly reduces the number of paths that must be computed by a designated nodal element.

For example, NE₁ (e.g., BGP speaker node) within cluster CL₁, may wish to route information to NE₂₁ within cluster CL₂. To do so, NE₁ may request that SE₁ compute a path to SE₂. In accordance with one embodiment of the present invention, SE₁ is operable to so compute the paths and forwarding tables associated with routing information to SE₂. It is the responsibility of SE₂ to compute a routing path to NE₂₁ within cluster CL₂. Alternatively, NE₁ need not send an explicit request on to SE₁. Instead, NE₁ may just forward a packet on to SE₁ , it being understood that SE₁ is the only element within the cluster capable of routing the packet on further.

One advantage of the hierarchical structure provided by the present invention can be illustrated by considering how SEs provided by the present invention operate when changes are made to a network topology. For example, if additional nodal elements are added to CL₁, it is only necessary for the SE₁ associated with CL₁ to compute new routing paths and forwarding tables to allow information to be routed between the newly added nodal elements and SEs outside the cluster. In contrast, existing techniques would require each BGP speaker node (e.g., each NE in FIG. 1) to re-compute new paths and forwarding tables to every new nodal element within cluster CL₁.

As for the NEs within a cluster, in an additional embodiment of the invention, they need not compute paths to any nodal elements outside the cluster, not even to an SE outside the cluster. Instead, they need only compute a path to their associated SE or, alternatively, to other NEs within their cluster that are then responsible for transferring information to the designated SE.

In sum, the present invention only requires each identified SE to re-compute paths and forwarding tables when changes occur to the network topology of its associated nodal cluster.

In an additional embodiment of the present invention, the present invention envisions a number of layers. For example, within a first layer there may exist all of the nodal elements which have not been designated as supernodes. Within a second layer, there exist all of the SEs which have been so designated. In yet a further embodiment of the invention, one or more of the designated SEs may also be grouped into clusters designated as “SCL_{1, . . . n}” in FIG. 1. Thereafter, one SE is designated as a “lead SE” or “LSE.” (Again, though FIG. 1 shows LSEs, it should be understood that this designation is made to an NE which has first been designated as an SE, then further designated as an LSE.) Analogous to an SE, it is only necessary for an LSE to compute routing paths and forwarding tables when changes occur to a given network topology of SEs within its cluster. These LSEs may form a third layer.

In turn, LSEs can also be organized into clusters from which a “super lead” SE or “SLSE” may be designated. These SLSEs may be viewed as forming a fourth layer. As will be appreciated by those skilled in the art, this process may continue until a number of layers have been created according to a given design. Within each layer, it is only necessary for designated cluster leaders to compute routing paths to other cluster leaders within the same layer, etc. . . . .

Backtracking somewhat, the present invention provides for a number of ways to designate a nodal element as a supernode (or a supernode as a lead supernode., etc.).

In one embodiment of the present invention, if the nodal elements form a so-called “tree structure” (a term known by those skilled in the art), then one nodal cluster layer may be formed by selecting the nodal element which forms the “root” of the tree (an SLSE, for example).

Similarly, the next nodal cluster layer may then be formed from so-called “children” of the root. For example, two LSEs may be children of an SLSE. These LSEs are themselves roots of their own nodal element trees. In sum, supernodes, lead supernodes, and super lead super nodes, etc. may be designated by determing the roots of tree-like nodal element formations.

In an alternative embodiment of the present invention, when nodal elements do not form a tree-like structure, the present invention provides for generating a virtual tree-like structure in order to designate supernodes, etc. For example, in one embodiment of the present invention, for any arbitrary network topology (that is connected), a subset of links can be selected to form a tree. This set of selected links may be referred to as a “spanning tree” structure. As is known in the art, there are many so-called spanning tree techniques, each designed to meet different constraints. For example, techniques exist which: (a) find a spanning tree such that the total cost (e.g., link delay) of all links that are selected is as small as possible; (b) find a spanning tree in which the maximum root length from a root to a nodal element is as small as possible; and (c) find a spanning tree in which the maximum number of children is as small as possible.

These and other spanning tree techniques may be used to form tree-like nodal element structures. Once the tree-like structures are formed, supernodes, etc. may be designated using the techniques described before. It should be understood that, depending on the desired objective or routing design, an appropriate spanning tree can be selected. For example, if a particular design requires that the number of nodal elements served by any supernode be as small as possible, then using the spanning tree technique described in (c) may be advantageous. However, if another design requires that a maximum root length between any pair of nodal elements be as small as possible, then the technique described in (b) may be advantageously used.

Referring again to FIG. 1, there is shown one or more controllers or the like 10, 100a, 100b, 100c, 1000 which may be used to designate nodal elements as supernodes, etc. For example, it may be that controller 1000 is operable to determine the supernodes, lead supernodes and super lead supernodes for all of the nodal elements shown in FIG. 1. Alternatively, each of the clusters may make use of their own controller 100a, 100b, 100c or 10 which is operable to determine a supernode, lead supernode, super lead supernode, or some combination of these. It should be further understood that such a controller may comprise hardware firmware, software or some combination of the three and may include a processing section and one or more memory sections for executing one or more programs to carry out the features and functions of the present invention including determining the “trees” and “roots” of a given network structure.

It should be further understood that a controller may also be operable to organize the nodal elements into one or more nodal clusters from which a supernode, lead supernode, or super lead supernode will be designated.

The above discussion has attempted to set forth some examples of the present invention. The true scope of the present invention, however, is reflected by the claims which follow.

We claim:

1. A method for generating a hierarchical structure for the Internet comprising:
organizing one or more nodal elements into at least one cluster; and
designating one of the nodal elements as an element operable to compute one or more routing paths to one or more other similarly designated elements outside of the cluster.

2. The method as in 1 wherein the designated element within the cluster is further operable to compute forwarding tables associated with the computed paths.

3. The method as in claim 1 wherein one or more of the nodal elements comprise a Border Gateway Protocol (BGP) speaker node.

4. The method as in claim 1 further comprising:
enabling each of the one or more nodal elements within the cluster to compute a routing path to the designated element.

5. The method as in claim 1 further comprising:
enabling each of the one or more nodal elements within the cluster to compute a routing path to every other nodal element within the cluster.

6. A method for generating a hierarchical structure for the Internet comprising:
creating one or more layers of nodal elements; and
computing routing paths from a designated nodal element within a cluster of a given layer to other similarly designated nodal elements outside of the cluster within the same layer.

7. A controller for generating a hierarchical structure for the Internet operable to:
organize one or more nodal elements into at least one cluster; and
designate one of the nodal elements as an element operable to compute one or more routing paths to one or more other similarly designated elements outside of the cluster.

8. A nodal element designated to compute one or more routing paths and forwarding tables associated with the computed paths to one or more other similarly designated elements outside of an associated cluster.

9. The system as in claim 8 wherein the designated element is a BGP speaker node.

10. A controller, for generating a hierarchical structure for the Internet, operable to:
create one or more layers of clustered nodal elements; and
designate an element within a cluster of a given layer to compute routing paths to other similarly designated elements outside of the cluster within the same layer.

11. A method for generating a hierarchical structure for the Internet comprising:
determining roots of a tree-like nodal structure formed from one or more nodal elements; and
designating each root as an element operable to compute one or more routing paths to one or more other similarly designated elements outside of an associated cluster.

12. The method as in claim 11 further comprising:
generating a virtual tree-like structure from the one or more nodal elements; and
determining the roots from the virtual tree-like structure.

13. The method as in claim 12 wherein the tree-like structure comprises a spanning-tree structure.
